(19) United States
(12) Patent Application Publication
(10) Pub. No.: US 2007/0056449 A1
(43) Pub. Date: Mar. 15, 2007

(54) Device for producing a sterilizable heated emulsion of milk and air

(76) Inventors: Fabrizia Di Giampaolo, Rodengo Saiano (Brascia-Italy) (IT); Gianbattista Marchesi, Credaro (Bergamo-Italy) (IT)

Correspondence Address: SHOEMAKER AND MATTARE, LTD, 10 POST OFFICE ROAD - SUITE 110, SILVER SPRING, MD, 20910, US

(21) Appl. No.: 10/574,799

(22) PCT Filed: Oct. 6, 2003
(86) PCT No.: PCT/IT03/00598

§ 371 Date: May 12, 2006

(51) Int. Cl. A23C 1/00

(52) U.S. Cl. 99/452

(57) ABSTRACT

The present invention relates to a device intended to produce a heated emulsion of a liquid, in particular milk, with air. The device comprises a body (10) in which there are obtained steam inlet, a drink inlet (12), an air inlet (13) and a mixing chamber (14) communicating with said inlets and with an emulsion delivery hole (15). Between the mixing chamber (14) and the delivery hole (15) there are provided valve means (17, 17′) capable of rotating between an open position, adapted for placing the mixing chamber (14) in fluid communication with the delivery hole (15), and a closed position of said mixing chamber, in which the steam jet is forced to exit from the body (10) passing through the air and drink inlets (12, 13), to sterilise the device.

The present invention relates to a device intended to produce a heated emulsion of a liquid, in particular milk, with air. In the specific case of milk, the resulting emulsion is used to produce the drink called “cappuccino”. The device is intended to be applied to coffee machines, both of the professional and of the household type.

Various embodiments of devices of this type are already known. In general, they comprise a body wherein there are obtained inlets for the fluids, for air and for a steam jet intended to heat the emulsion, a mixing chamber and an outlet.

One of the most widely felt problems connected to the use of these devices is the need of sterilising them to prevent the forming of dirt and bacteria. Given their small size and the inaccessibility to the user, in fact, the inlets can be a fertile ground for moulds and bacteria or, in any case, for deposits of dirt to be removed.

A proposal has already been made to use the same steam jet to clean and sterilise the device body at high temperature. The outlet must therefore be closed so that the steam circulates in the device and exits from the fluid and air inlets, thereby sterilising them. However, in all known devices, besides being often relatively difficult and complicated, this sterilisation function has implied a higher complexity of the appliance structure.

For example, a device provided with a plug or cover to be tightened on the outlet has been proposed. In another embodiment, such as that described in patent FP 0 801 922, the mixing chamber or duct is obtained into an inside body, longitudinally sliding into an outside body between a raised open position of the delivery hole, and a lowered closed position of said hole.

Based on these premises, the main object of the present invention is that of proposing a device for producing a heated emulsion of a drink, in particular milk, and water, provided with means for sterilising it by a steam jet and having a simpler and more reliable structure than that of the devices mentioned with reference to the prior art.

Such object is achieved by a device characterised in that it houses, into a mixing chamber or duct ending with a delivery hole, valve means capable of rotating between an open position, adapted for allowing the emulsion to reach the delivery hole, and a closed position to allow a steam circulation towards the drink and air inlets.

According to a preferred embodiment of the invention, such valve means comprise two ceramic plates of the type commonly used in the cartridges of mixing taps, said plates being constrained to respective portions of the body, capable of rotating relative to one another.

Further features and advantages of the device according to the present invention will appear more clearly from the following description of a preferred embodiment, made by way of a non-limiting example with reference to the attached drawings, wherein:

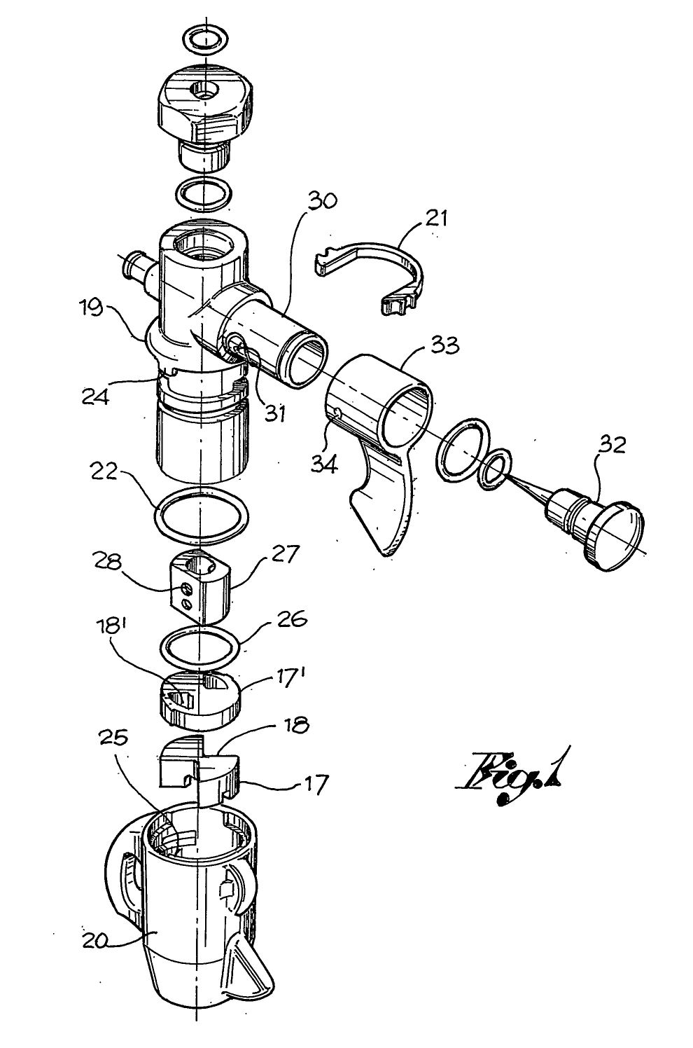

FIG. 1 shows an exploded perspective view of the device according to the invention;

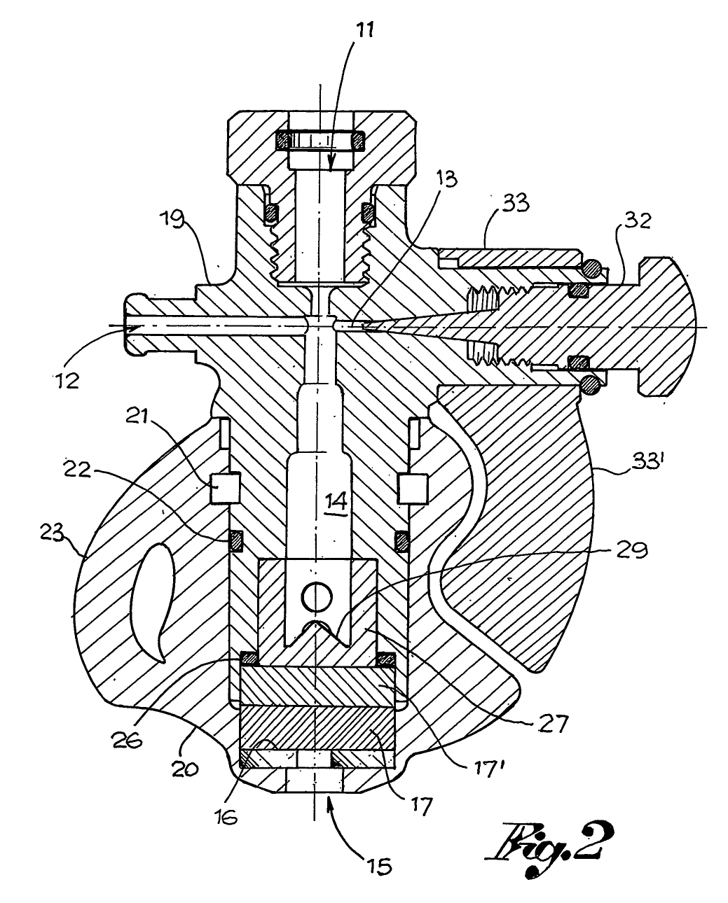

FIG. 2 shows a longitudinal section of the assembled device;

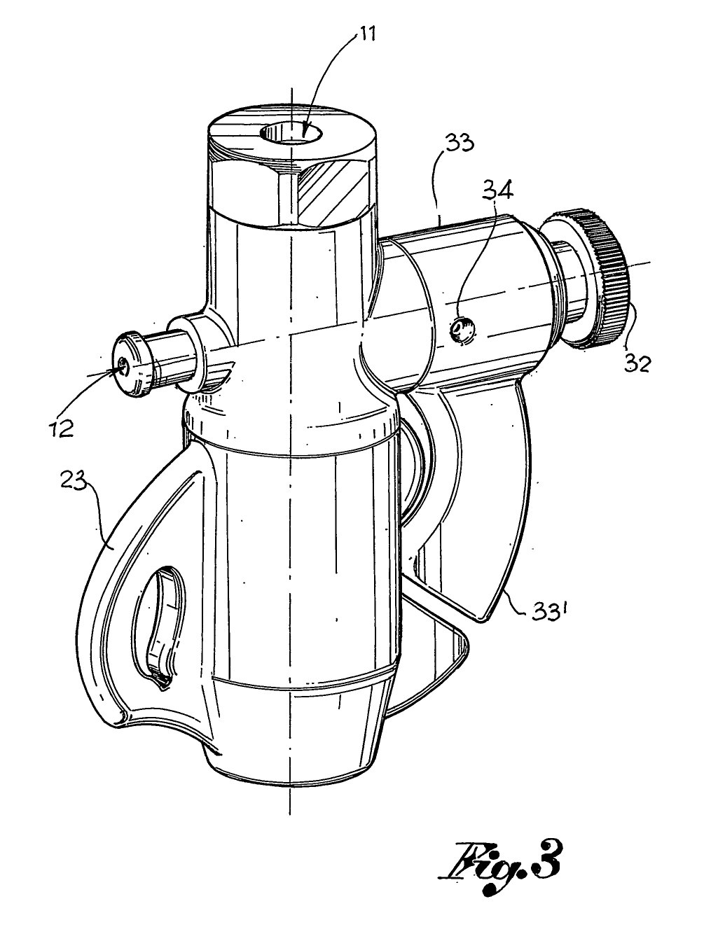

FIG. 3 shows a perspective view of the device set up for normal operation;

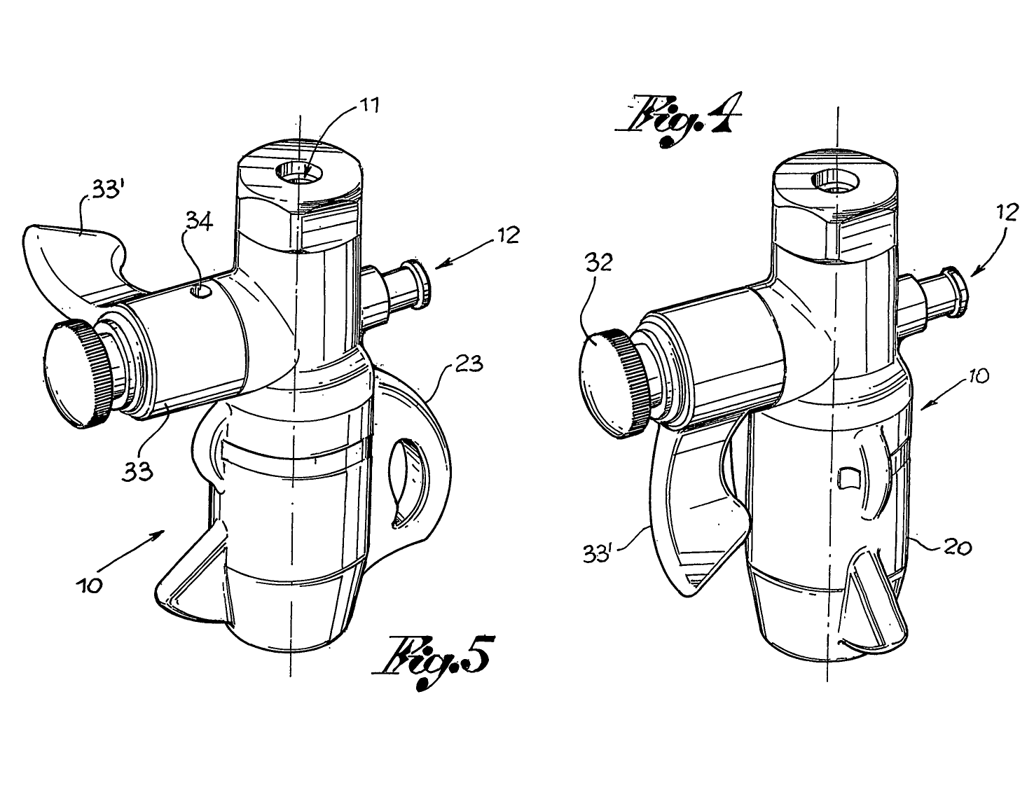

FIG. 4 shows the device in position to be cleaned; and

FIG. 5 shows the device in position for delivering a heated drink without foam.

With the purpose of simplifying the description of the present invention, in the following description reference shall be made in a non-limiting way to the particular example of a device adapted for producing the so-called “cappuccino” mixing milk, air and steam.

The device comprises a body 10 wherein there are obtained an inlet 11 for a steam flow, an inlet 12 for milk, and an inlet 13 for air. The three inlets outflow into a mixing chamber 14, for example aligned and continuing from the steam inlet, which extends towards a hole 15 for delivering the milk-air emulsion with an increasing section profile. Such profile has the function of producing a Venturi effect so that the steam jet flow causes an intake of milk and air into the mixing chamber through the respective inlets.

According to the finding, a seat 16 is provided between the mixing chamber 14 and the delivery chamber 15 wherein there are housed valve means capable of rotating between an open position, adapted for placing the mixing chamber 14 in fluid communication with the delivery hole 15, and a closed position of said mixing chamber.

According to a preferred embodiment of the invention, said valve means comprise two superimposed ceramic plates 17, 17′, of the type commonly used in mixing taps, one rotating relative to the other. Such plates exhibit respective fissures or openings 18, 18′ obtained so as to be aligned and therefore define passage gaps for the fluid, when the plates are in open position, or not aligned, with consequent closing of said passage gaps when the plates are rotated in closed position.

Inlets 11-13 and the mixing chamber 14 are obtained in a top portion 19 of body 10, having a substantially cylindrical shape, coupled with a bottom portion 20 wherein there is obtained the hole 15 for delivering the emulsion. In the illustrated example, the bottom portion 20 of the body is shaped as a bowl intended to receive a bottom portion of the top portion 19 of body 10. In any case, the two portions 19 and 20 are turnably coupled with respect to one another and are axially constrained, for example by a seeger 21, with the interposition of a sealing element 22.

The bottom ceramic plate 17 is housed and locked in the bottom portion 20 of body 10, whereas the top ceramic plate 17′ is constrained at least angularly to the top portion 19 of body 10. In this way, a simple rotation of a part of the body relative to the other causes a corresponding rotation of a plate relative to the adjacent one, and thereby the passage from the open position to the closed position of the mixing chamber 14 towards the delivery hole 15, or vice versa.

Advantageously, the bottom portion 20 of body 10 is provided with a gripping handle 23 to be rotated relative to the top portion 19 which, on the other hand, is fixed since it is constrained to the steam and milk feeding pipes—not shown.

Using ceramic plates 17, 17′ such as those illustrated in the drawings, the opening and closing of the passage gaps can be obtained by a hexagesimal 90° rotation with respect to one another, that is, of the bottom portion of the body with respect to the top one. To this purpose, the top portion 19 of the body is provided with at least one radial tooth 24 that can move between two shoulders 25 obtained in the bottom portion 20 and spaced from one another by an arc of a circumference of hexagesimal 90°.

So, with a simple rotation of the bottom portion 20 of body 10 (FIG. 4), it is possible to close the delivery hole 15 and it is therefore possible to let a steam jet into the device so that, since it cannot exit from said hole 15, it is forced to flow through the air 13 and milk 12 inlets, thereby sterilising them.

Moreover, in the section with the largest diameter in the mixing chamber 14, on the top plate 17′ and with the interposition of a sealing element 26, there is housed an insert 27 intended to suitably decrease the speed of the fluid flowing into the mixing chamber to reduce the forming of bubbles. To this purpose, insert 27 exhibits radial holes 28 and a conical shaped closed bottom 29.

The air inlet 13 is obtained in a cylindrical projection 30 overhanging the top portion 19 of body 10 and it communicates with the outside through a feeding hole 31 obtained radially with respect to the main axis of said cylindrical projection 30. Inlet 13 is associated with a pin valve 32 adapted for regulating—through a higher or lower screwing into the cylindrical projection—the quantity of air to be sucked into the device.

According to the invention, an annular element 33 crossed by a radial hole 34 is fitted on said cylindrical projection with possibility of rotation. According to the angular position of the annular element 33, the radial hole 34 can be aligned with the air feeding hole 31 or not aligned with it, thereby preventing the air inlet into the device. If the user only desires heated milk without foam, it is sufficient to rotate the annular element 33 (FIG. 5) to fully close the air feeding hole 31, without acting on the pin valve 32. For a convenient rotation, the annular element 33 is provided with an actuation lever 33′.

In this way it is possible to avoid the disadvantage common to the embodiments known so far, that once the optimum pin valve position has been determined—often after several attempts—to obtain the desired emulsion according to one's tastes, a further movement from said position, for example in closed position of the air inlet hole, to produce only the heated drink, requires a new search of the ideal position determined before.

1-20. (canceled)

21. A device for producing a heated emulsion of a drink, in particular milk, and air with the aid of a steam jet, comprising a body wherein there are obtained at least one steam inlet, a drink inlet, an air inlet and a mixing chamber for the drink, air and steam, where said mixing chamber communicates with said inlets and with a hole for delivering the emulsion, wherein between the mixing chamber and the delivery hole there are provided valve means capable of rotating between an open position adapted for placing the mixing chamber in fluid communication with the delivery hole and a closed position of said mixing chamber, wherein the steam jet is forced to exit from the body passing through the air and drink inlets, to sterilise the device.

22. Device according to claim 21, wherein said valve means comprise a pair of superimposed ceramic plates capable of axially rotating with respect to one another between the open position and the closed position.

23. Device according to claim 22, wherein said plates exhibit respective fissures or openings obtained so as to be aligned, when the plates are in open position, and not aligned when the plates are in closed position.

24. Device according to claim 21, wherein the body comprises a top portion and a bottom portion axially constrained with possibility of angular movements with respect to one another.

25. Device according to claim 24, wherein the rotation of a portion of the body relative to the other is limited to an angle of hexagesimal 90°.

26. Device according to claims 2, wherein the body comprises a top portion and a bottom portion axially constrained with possibility of angular movements with respect to one another, and wherein at least one plate is constrained at least angularly to a respective portion of the body.

27. Device according to claim 22, wherein the plates are capable of rotating by hexagesimal 90° with respect to one another.

28. Device according to claim 24, wherein one of the two portions exhibits a radial tooth movable between two support shoulders obtained in the other portion.

29. Device according to claim 21, wherein the air inlet is obtained in a cylindrical projection of the body and is open outwards through a hole obtained radially with respect to the main axis of said cylindrical projection.

30. Device according to claim 29, wherein around said cylindrical projection there is mounted an annular element bearing a radial hole, said annular element being capable of rotating on the cylindrical projection between an open position of the air inlet, wherein the radial holes of the cylindrical projection and of the annular element are aligned, and a closed position of said inlet wherein said holes are not aligned.

31. Device according to claim 21, wherein the air inlet is provided with a valve for regulating the air quantity to be let into the device.

32. Device according to claim 31, wherein said valve is a pin valve.

33. Device according to claim 21, wherein the mixing chamber exhibits a plurality of sections with an increasing diameter towards the emulsion delivery hole.

34. Device according to claim 33, wherein the valve means are housed in the section with the largest diameter.

35. Device according to claim 30, wherein an insert is placed to decrease the speed of the emulsion flow.

36. Device according to claim 35, wherein said insert is provided with radial gaps.

37. Device according to claim 35, wherein said insert is closed at the bottom by a conical shaped bottom.

38. Device for producing a heated emulsion of a drink, in particular milk, and air with the aid of a steam jet, comprising a body wherein there are obtained at least one steam inlet, a drink inlet, an air inlet and a mixing chamber for the drink, air and steam, where the air inlet is obtained in a cylindrical projection of the body and is open outwards through a hole obtained radially with respect to the main axis of said cylindrical projection, wherein around said cylindrical projection there is mounted an annular element bearing a radial hole, said annular element being capable of rotating on the cylindrical projection between an open position of the air inlet, wherein the radial holes of the cylindrical projection and of the annular element are aligned, and a closed position of said inlet wherein said holes are not aligned.

39. Device according to claim 38, wherein the air inlet is associated with a valve for regulating the air quantity to be let into the device.

40. Device according to claim 39, wherein said valve is a pin valve.
